(19) United States
(12) Patent Application Publication
(10) Pub. No.: US 2002/0036865 A1
(43) Pub. Date: Mar. 28, 2002

(54) Digital audio recorder in cassette form

(76) Inventors: Sean Harris, Bayside, NY (US); Jerry Tam, Flushing, NY (US)

Correspondence Address: PERMAN & GREEN, 425 POST ROAD, FAIRFIELD, CT, 06430, US

(21) Appl. No.: 09/774,392

(22) Filed: Jan. 31, 2001

Related U.S. Application Data
(60) Provisional application No. 60/179,311, filed on Jan. 31, 2000.

(51) Int. Cl. G11B 23/02

(52) U.S. Cl. 360/132

(57) ABSTRACT

A digital audio recorder in the form of a tape cassette includes a housing having a shape so as to be mountable interchangeably with a cassette tape reproduced in a cassette tape audio reproduction apparatus. A signal output head is built in the housing and arranged in opposed relationship to a reproduction head for reproducing audio stored on the cassette tape in the cassette tape reproduction apparatus thereby to transmit a signal to the reproduction head. The signal output head has a head cover. A head spring elastically supports the head cover with respect to the housing, thereby positioning the head in such a manner that the position of the head causes the head to come into contact with a reference surface of the tape guide of the cassette tape reproduction apparatus.

This application claims priority of provisional patent application 60/179,311 filed on Jan. 31, 2000.

### FIELD OF THE INVENTION

The present invention relates to the storage of a digitally compressed audio signal. More particularly, it relates to the storage of digital audio data and to its remodulation into an analog audio signal to enable playback in a standard audio cassette player.

### BACKGROUND OF THE INVENTION

Signal compression is the translation of a signal from a first form to a second form wherein the second form is typically more compact (either in terms of storage volume or bandwidth). For example, suppose the number of cars that passes a busy intersection is logged in a computer every twenty minutes over the course of a week. This may generate hundreds of pages of raw data. After the information is collected a summary report is produced which displays an average of the number of cars which passed the intersection that week.

The summary report is a compressed version of the hundreds of pages of raw data. Audio files are compressed similarly using the Mpeg layer 3 open standard. Layer 3 is one of three coding schemes (Layer 1, Layer 2 and Layer 3) for the compression of audio signals. This involves the use of perceptual audio coding and psychoaucoustic compression to remove all superfluous information (more specifically the redundant and irrelevant part of a sound signal, the information not heard by human ear anyway). It also adds MDCT (Modified Discrete Cosine Transform) that implements a filter bank, increasing the frequency resolution eighteen times higher than that of Layer 2.

The result in real terms is that Layer 3 compresses the volume of audio data from a compact disc by a factor of twelve without sacrificing sound quality. For example, a bit rate of 1411.2 kb/sec may be converted to a bit rate of bit rate of 141.12 kb/sec. Since MP3 files are so small they are ideal for transmission across the internet or storage on a relatively compact medium.

### SUMMARY OF THE INVENTION

It is an object of the invention to provide a simple and compact digital audio recorder.

It is another object of the invention to provide a digital audio recorder that can record music files distributed via the internet.

It is a further object of the invention to provide a digital audio recorder in the general form of a tape cassette which allows the recorded audio to be played back through a standard tape cassette player.

In order to achieve the afore-mentioned objects, the invention comprises:

A housing having such a shape as to be mountable interchangeably with cassette tape reproduced in a cassette tape reproduction apparatus;

A signal output head built in the housing and arranged in opposed relationship to the reproduction head for reproducing the cassette tape of the cassette tape reproduction apparatus thereby to transmit a signal to the reproduction head;

The invention further comprises a head spring for elastically supporting the head cover with respect to the housing, thereby positioning the head in such a manner that the position of the head comes into contact with a reference surface of the tape guide of the cassette tape reproduction apparatus.

A head cover for accommodating and holding the head in a predetermined positional relationship with the housing, the head cover having a dummy tape member adapted to engage the tape guide of the cassette tape reproduction apparatus for guiding the head to a position in opposed relationship with the reproduction head.

The endless pseudo tape is driven at a constant speed by the capstan and the pinch roller of the cassette reproduction apparatus so that the reel on which the pseudo tape is suspended rotates without any sliding. As a result, the cassette tape reproduction apparatus having the invention mounted therein free of an erroneous judgement that the tape has broken and also free of the faulty operation of automatically stopping or automatically unloading the invention.

The invention also possess a headphone output base thereby allowing signal output directly to user in the condition where a cassette tape reproduction apparatus is not available.

### DETAILED DESCRIPTION OF THE INVENTION

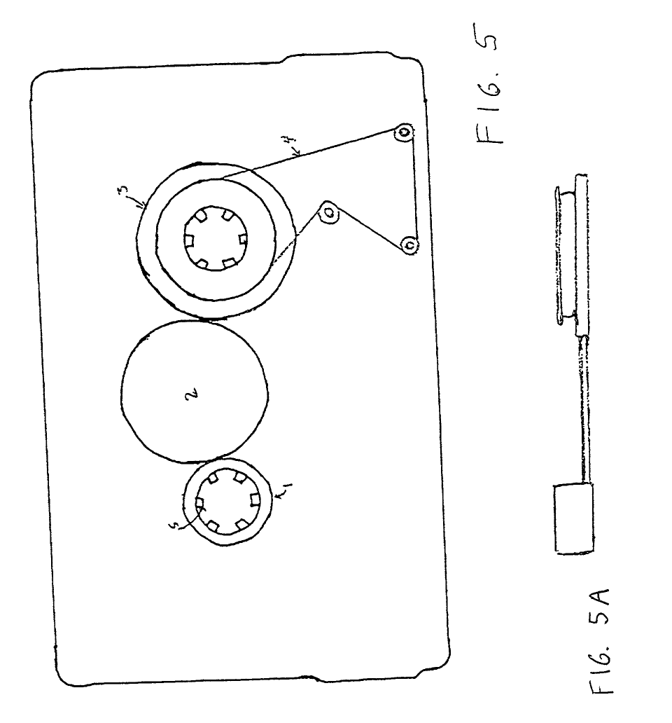

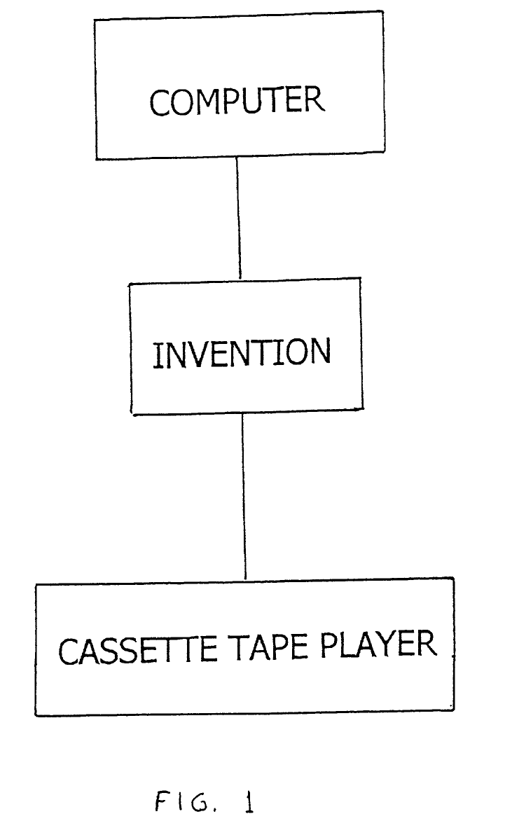

FIG. 1 is an illustration of the flow of data from the computer to the invention to the cassette player.

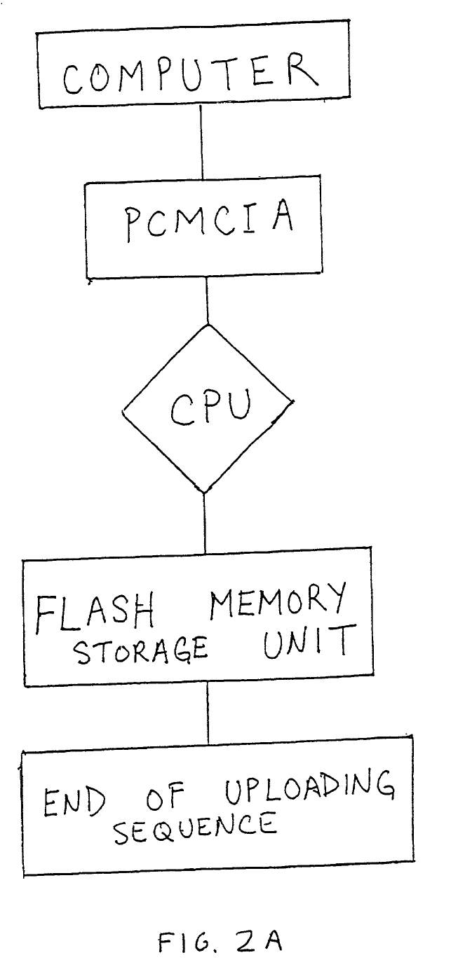

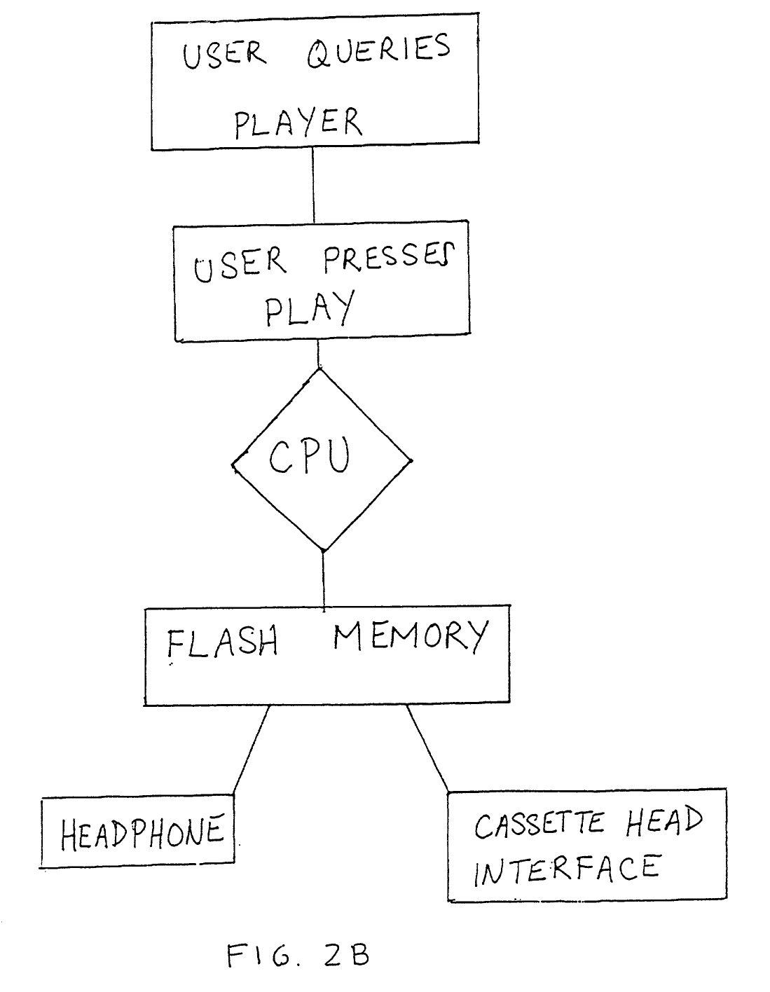

FIG. 2A is a flow chart illustrates the uploading sequence of data from the computer to the invention. It serves as a further, more detailed illustration of the logical steps that are used so that data flows from the computer to the device. In this illustration data follows the path from the computer entering the invention through the PCMCIA interface. From the PCMCIA interface the data goes to the processor and then to the EEPROM chipset for storage. The uploading sequence terminates at this point.

FIG. 2B is a flow chart that illustrates the playback sequence. Here the user initiates a query to the processor. The processor retrieves the data from the EEPROM and sends the data, converted into analog form, to both the headphone jack and the signal head interface for a cassette player.

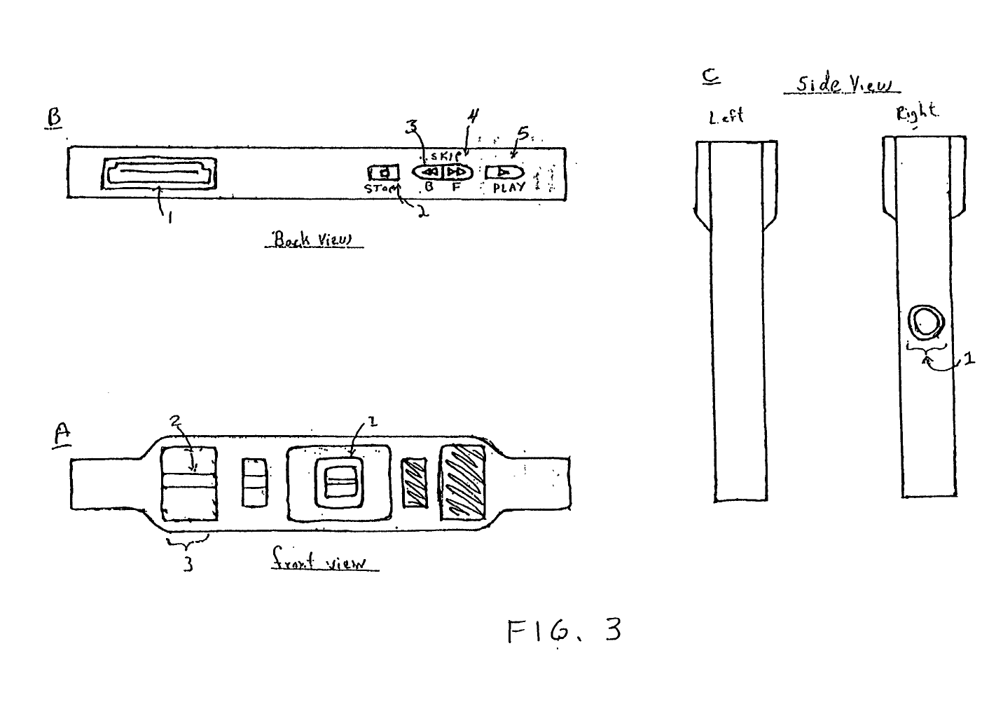

FIG. 3A is a front view of an embodiment of the invention, which illustrates the signal head interface and counter anti-rolling mechanism. Item 1 is the Signal head interface. Item 2 Is the counter anti-rolling tape. The counter anti-rolling tape seen from this perspective consists of a piece of plastic threaded through the space designated as item 3.

FIG. 3B is the back view of the embodiment of the invention. In this view, item 1 illustrates the female PCMCIA interface. Item 2 illustrates the stop button for the invention. Item 3 illustrates the replay button of the invention. Item 4 illustrates the skip selection button for the invention. Item 5 illustrates the play selection button for the invention.

FIG. 3C is the Side View of the illustrated embodiment of the invention. In this view, item 1 illustrates the headphone interface.

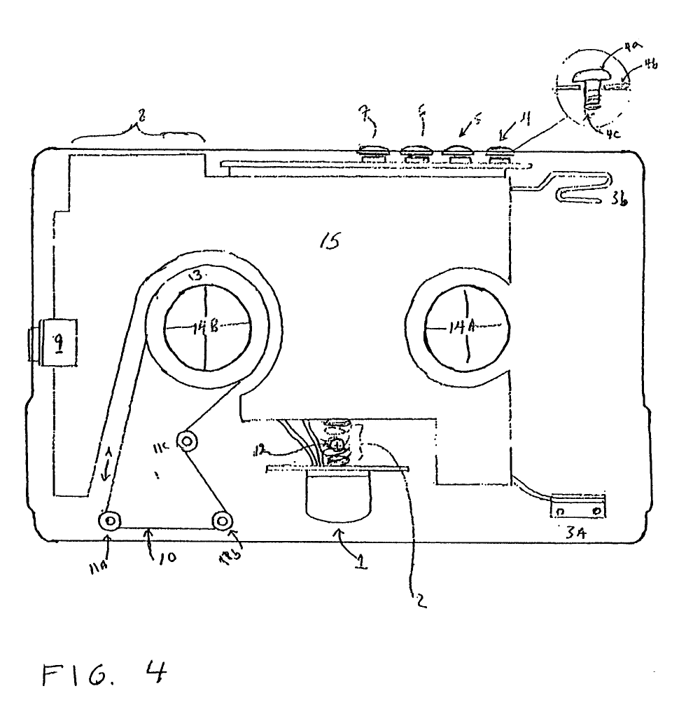

FIG. 4 illustrates the interior view of the illustrated embodiment of the invention. In this view item one is the signal head interface. Item 2 Is the position retention spring for the signal head interface. Item 12 is the position retention spring retainer. Items 3a and 3b are plan views of the battery connectors as they would be connected to the circuit board, which is item 15, for supplying power thereto. Item 4 Is the play button. (See inset) This consists of a piece of plastic 4a fashioned in the shape of a “T.” A spring 4c is attached to the base of the button. The purpose of the spring is to return the button back to the original position after it has been depressed and released. Item 4b is a cross-sectional view of a portion of the housing of the illustrated embodiment of the invention, which is adjacent the play button (item 4).

Item 5 is a view of the skip selection button, which is fashioned in the same manner as FIG. 4. Item 6 is a view of the replay selection button, which is fashioned in the same manner as FIG. 4. Item 7 is a view of the stop selection button, also fashioned in the same manner as FIG. 4. Item 8 is a view of the female PCMCIA interface. Item 9 is a view of the headphone interface. Item 10 is the counter anti-rolling mechanism simulator tape that runs in the direction of arrow A. The purpose of this tape is to serve as a dummy tape member, thus simulating the presence of an unrolled tape. This “fools” the anti-rolling mechanism built into many tape players into sensing that a conventional audio cassette is present. Item 11a, 11b and 11c are guidepost for the counter anti-rolling simulator tape. They serve to properly align the counter anti-rolling simulator tape with the anti-rolling mechanism. Item 13 illustrates the drive wheel for the counter anti rolling simulator. The turning motion of the reel hub causes the motion of the drive wheel. Items 14a and 14b are views of space provided for the reel hubs present in tape players. Item 15 illustrates the circuit board in its preferred embodiment. It will be understood that the circuit board will contain a chip set and other associated electronic components sufficient to perform the operations required to implement the flow chart of FIG. 2A.

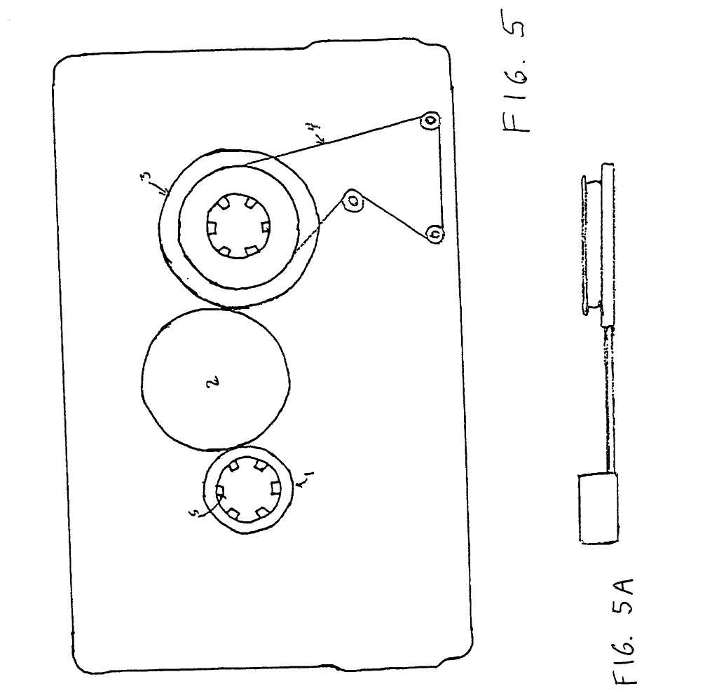

FIG. 5 is a more detailed plan view of the counter anti-rolling mechanism, while FIG. 5A is a side elevational view. Items 1 and 3 are timing wheels. The wheels have teeth, depicted here as members 5. The gear teeth engage with those of the tape player reel and rotate at the same speed. Item 2 is the intermediate timing gear. Its motion causes one timing wheel to rotate in the opposite direction of the other. The result is that the dummy tape member is rotated in the direction opposite to the rotation of the reel hub.

What is claimed is:

1. An apparatus comprising:
a housing having a shape so as to be mountable interchangeably with cassette tape reproduced in a cassette tape audio reproduction apparatus;
a signal output head built in the housing and arranged in opposed relationship to a reproduction head for reproducing audio stored on the cassette tape in the cassette tape reproduction apparatus thereby to transmit a signal to the reproduction head, the signal output head having a head cover;
a head spring for elastically supporting the head cover with respect to the housing, thereby positioning the head in such a manner that the position of the head causes the head to come into contact with a reference surface of the tape guide of the cassette tape reproduction apparatus;
the head cover being for accommodating and holding the head in a predetermined positional relationship with the housing, the head cover having a pseudo tape member adapted to engage the tape guide of the cassette tape reproduction apparatus for guiding the head to a position in opposed relationship with the reproduction head.

2. The apparatus of claim 1 wherein the pseudo tape is endless and is driven at a constant speed by a capstan and a pinch roller of the cassette reproduction apparatus so that a reel on which the pseudo tape is suspended rotates without any sliding.

3. The apparatus of claim 1 further comprising a headphone output for providing a signal directly to a user.
